(19) United States
(12) Patent Application Publication
(10) Pub. No.: US 2007/0129918 A1
(43) Pub. Date: Jun. 7, 2007

(54) Apparatus and method for expressing wetting and drying on surface of 3D object for visual effects

(76) Inventors: Soon Hyoung Pyo, Daejeon (KR); Bon Ki Koo, Daejeon (KR); Manjai Lee, Seoul (KR)

Correspondence Address: LADAS & PARRY LLP, 224 SOUTH MICHIGAN AVENUE, SUITE 1600, CHICAGO, IL, 60604, US

(21) Appl. No.: 11/500,647

(22) Filed: Aug. 8, 2006

(30) Foreign Application Priority Data
Dec. 6, 2005 (KR) 2005-0118381

(51) Int. Cl. G06G 7/50

(52) U.S. Cl. 703/9

(57) ABSTRACT

An apparatus and a method for expressing wetting and drying on an object surface are provided. The apparatus includes an adding water mark module adding new water on an object surface from a particle or a mesh representing water in outside environment, a wetting module considering water affinity of the object surface, a 2D fluid simulation module processing a flow of water particles in excess of a wet capacity of the object, and a drying module drying a drying wet portion after a predetermined time elapses. Moreover, a characteristic change of the object surface can be expressed, which is caused by water contact in the object surface interacting with water, and also water affinity can be expressed using a wetting capacity and a drying time. Therefore, detailed expression of water is possible when water exists in a scene, and various scenes with water can be depicted more realistically, which is a very important component of special effects.

### BACKGROUND OF THE INVENTION

1. Field of the Invention

The present invention relates to an apparatus and a method for expressing how a result of a water simulation used in animations and movies effects the surface of a 3D object, and more particularly, to an apparatus and a method for expressing wetting and drying of an object surface with water in water animations for creating visual special effects of animations and movies.

2. Description of the Related Art

Studies for fluids such as water and gas have been actively developed in various fields. Especially, the fluid mechanics is variously applied to the image industries with the graphics, and also widens its application range. However, since most of systems are controlled by solutions of the complicated equation and parameter values corresponding to the specific situation, it is difficult to express complicated natural phenomena. Accordingly, since fluid can be variously responsive to a small change of a surrounding environment due to characteristics of the fluid, it is hard to model the fluid in a user-wanted shape and accurately simulate the fluid. That is, expressions for irregular natural phenomenon such as water movement, a gas flow, and a shape of cloud are a difficult and interesting field in computer graphics.

Recently, although water expression in various movies and animations stands out as an important component and many techniques are under development, it is limited to express the movement of water itself or the interaction related to an object with restricted conditions. Moreover, there have been few studies for actually expressing the absorbing and wetting of water when considering object characteristics and the drying of water when time elapses in the case of interactions between the water and the object. Accordingly, a method for expressing the interactions between an absorbing object and water, that is, wetting and drying of the surface with wetting phenomenon like cloth is necessary and thus will now be described in this invention.

### SUMMARY OF THE INVENTION

Accordingly, the present invention is directed to an apparatus for expressing wetting and drying on an object surface, which substantially obviate one or more problems due to limitations and disadvantages of the related art.

It is an object of the present invention to provide an apparatus for expressing wetting and drying on an object surface, which is for a characteristic expression of the object surface that interacts with water, and not a simulation based on a physical realism, and also for a visual imitation of wetting and drying on the basis of the characteristic expression.

It is another object of the present invention to provide a method for expressing wetting and drying of water on an object surface in water animations used for a visual special effect generation of animations and movies.

It is a further another object of the present invention to provide an apparatus and a method for expressing wetting and drying on an object surface including methods of a relationship between water and an object surface, a expression of original water affinity of an object, and a expression of a water particle movement and a state change in an object surface.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for expressing wetting and drying on an object surface, the apparatus including: an adding water mark module searching positions of waterdrops contacted with an object surface to add water mark to the object surface; a wetting module using water affinity of the object surface to move water particles to the positions of the waterdrops; a 2D fluid simulation module simulating a flow of surplus water particles in excess of a wet capacity according to the water affinity of the object surface to calculate speed values of the surplus water particles; and a drying module removing old water particles that pass a predetermined time to express wetting on the object surface after comparing time of each frame.

In another aspect of the present invention, there is provided a method for expressing wetting and drying on an object surface, the method including: adding water mark to an object surface after searching positions of waterdrops contacted with the object surface; adding water particles to the added water mark using water affinity of the object surface, dividing the object surface of a 2D lattice into wetting portion and drying portion, and managing surplus water particle information in each cell constituting the 2D lattice; simulating a flow of surplus water particles in excess of a wet capacity according to the water affinity of the object surface to calculate speed values of the surplus water particles; expressing wetting of the object surface by completing water particle distribution of the object surface after using the calculated speed values of the surplus water particles to move the surplus water particles; and expressing drying of the object surface by comparing a wetting time of each cell in each frame to remove old water particles that passes a predetermined time.

The object surface is expressed as a 2D lattice, and each cell constituting the 2D lattice has a limitation in accommodating the number of the water particles according to characteristics of the object surface. The water affinity of the object surface is expressed using the wetting capacity of each cell constituting the 2D lattice and a drying time of wet cells.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating a structure of an apparatus for expressing wetting and drying of an object surface according to an embodiment of the present invention;

FIG. 2 is a block diagram illustrating operations of each module in an apparatus for expressing wetting and drying of an object surface according to an embodiment of the present invention; and

FIG. 3 is a flowchart illustrating operations of an apparatus for expressing wetting and drying of an object surface according to an embodiment of the present invention.

### DETAILED DESCRIPTION OF THE INVENTION

An apparatus and a method for expressing wetting and drying of an object surface will now be described in detail with reference to the accompanying drawings. An embodiment of the present invention can be various, and it will be apparent to those skilled in the art that objects, characteristics, and advantages of the present invention exist through an embodiment of the present invention.

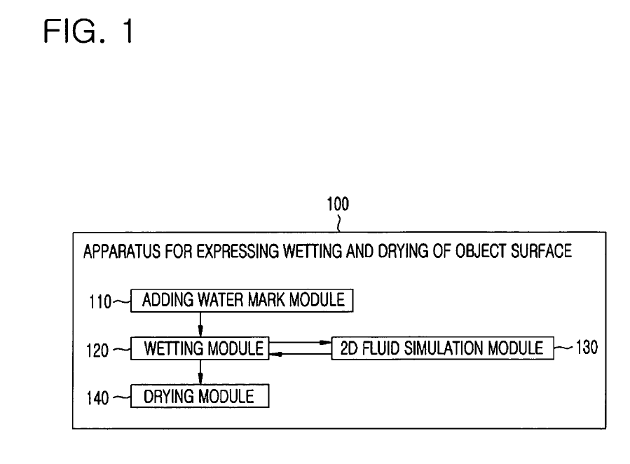

FIG. 1 is a block diagram illustrating a structure of an apparatus 100 for expressing wetting and drying of an object surface according to an embodiment of the present invention.

The apparatus 100 for expressing wetting and drying of an object surface includes an adding water mark module 110, a wetting module 120, a 2D fluid simulation module 130, and a drying module 140.

The adding water mark module 110 extracts information of water, which affects an object surface, from a simulation result generated using an external 3D simulator 200, and adds new information to the extracted information. The wetting module 120 expresses an object surface as a 2D lattice, divides the object surface into a wet area and a dry area by reflecting the added information when the water mark, which affects the object surface is added, and manages surplus water particle information at each cell of the lattice. The 2D fluid simulation module 130 calculates speed values to move the surplus water particles in wet cells. The drying module 140 removes old water particles by reflecting time of each cell with respect to the water mark added to the object surface.

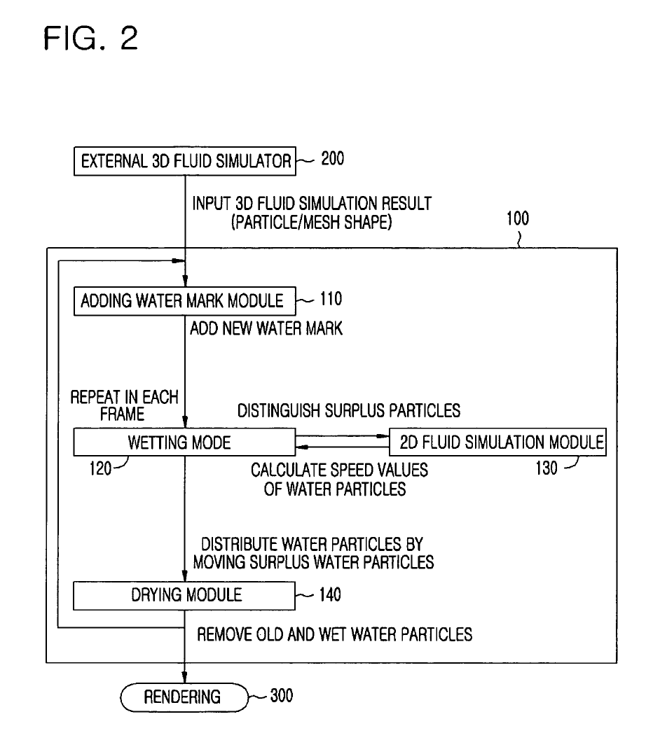

FIG. 2 is a block diagram illustrating operations of each module in the apparatus 100 of FIG. 1 for expressing wetting and drying of an object surface according to an embodiment of the present invention.

When examining each module operation in the apparatus 100, the adding water mark module 110 receives particles or mesh information as an input, which is generated using the external 3D simulator 200. Vertex information of the particles and the mesh is regarded as one waterdrop and used, and the adding water mark module 110 searches position information of each vertex of the particles and the mesh to find out waterdrops contacted with the object.

When the waterdrop is contacted with the object, the wetting module 120 expresses the waterdrop as a mark in circle or oval shape. The wetting module 120 can generate mark of a contact point by considering the orientation when speed information is utilized as an input.

The wetting module 120 receives waterdrops contacted with the objects as an input, and distributes new water particles to a corresponding point. The object surface is expressed in a 2D lattice shape, and each cell constituting the lattice has a limitation in accommodating the number of water particles according to object surface properties (i.e. capacity, etc.). The capacity is related to the water affinity of the object, and thus when the capacity is large, it means that the object can absorb a large amount of water.

The inputted position of the waterdrop covers a plurality of cells according to a mark shape. Additionally, the wetting module 120 divides the total number of water particles in one waterdrop, and uniformly or appropriately distributes and adds the divided water particles to each cell. Additionally, the wetting module 120 adds water particles to the cell when the number of the water particles in each cell is less than the capacity of the cell, and if not, displays as surplus water particles and retains the water particles.

The 2D fluid simulation module 130 performs a simulation and generates a speed value at each cell using location information of cells, on which waterdrop is located, and gravity. Next, the wetting module 120 moves surplus particles in each cell to another cell using the speed values calculated in the 2D fluid simulation module 130 and heuristics. In practical heuristics, there is a method in which surplus particles are moved to cells among adjacent cells in a direction of a simulated speed. The method generates an effect in which flowing water follows pre-existed flowing water. The role of the wetting module 120 is completed when surplus particles are moved with respect to all cells. Additionally, a record of particles, which are added recently, is separately stored in a 2D grid for expressing the object surface. Thus, the record may be used in drying module 140 later.

The 2D fluid simulation module 130 performs a fluid simulation based on the 2D lattice and calculates a speed value in each cell using wet portion information of the lattice utilized in the wetting module 120. When it is possible to calculate the speed value of each cell, any simulation method can be possible and also the simulation method is not included within the scope of the present invention.

The drying module 140 searches wet cells of the 2D lattice and removes old particles after all particles are moved. Since the time of when particles are added recently, i.e. frame information, is recorded in each cell of the lattice, the drying module 140 compares information of when the particles are added with a current frame, and removes the predetermined number of old and wet water particles when sufficient time elapses. A reference time for drying is designated by a user, which represents water affinity of the object together with capacity of each cell.

Once this process is completed, wetting and drying expression of one frame is finished and the result is realized through a shader and can be available in rendering. Since the number of water particles in each cell is degree of wetting at a point where each cell represents, wetting and drying can be rendered using a color of a different depth according to the value of the wetting.

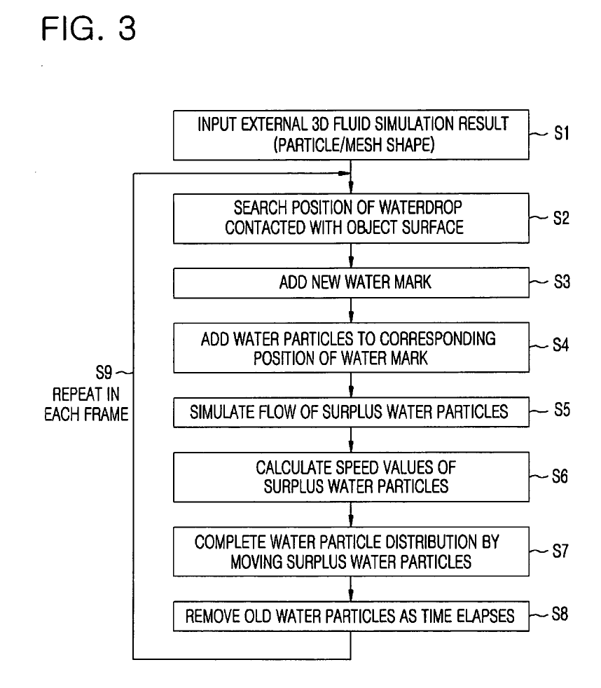

FIG. 3 is a flowchart illustrating operations of an apparatus for expressing wetting and drying of an object surface according to an embodiment of the present invention.

In operation S1, the adding water mark module 110 receives each frame result in a particle or a mesh shape as an input from the external 3D simulator 200. Position information corresponding to each particle of the input is regarded as one waterdrop, and each vertex constituting the mesh is regarded as one waterdrop and used when the mesh is inputted.

When these series of inputs are given, the adding water mark module 110 searches waterdrops contacted with the current object in operation S2, and adds new water mark in operation S3. Additionally, the adding water mark module 110 passes position information of the corresponding water mark to the wetting module 120.

The wetting module 120 includes 2D lattice information corresponding to the object surface and adds water particles to a corresponding position using location information of new water mark from the adding water mark module 110 in operation S4. At this point, each cell of the lattice determines the number of water particles, i.e. capacity, according to water affinity of the object, fills each cell with water particles to the capacity, and manages surplus particles separately in operation S4.

The 2D fluid simulation module 130 simulates a water movement using currently wet cell information and gravity information in operation S5, and calculates speed values of surplus water particles in each cell in operation S6. The wetting module 120 moves the surplus particles to complete particle distribution of the object surface by applying the speed values generated from a simulation result and heuristic in operation S7.

The drying module 140 searches each wet cell using the result and removes the predetermined number of particles when cells exceeds a predetermined time on the basis of the last wet time to express dryness of each cell in operation S8.

This process is performed on one frame, and the process repeats at each frame. The final result is again used as previous state of the next frame, and thus wetting and drying are expressed as time elapses in operation S9. Entire configuration of the present invention is not limited to methodology each module.

As described the above, an apparatus and a method for expressing wetting and drying of an object surface provide additional functions of water expression through simulation by expressing the object surface characteristics change according to the water contact in the object surface interacted with water, and object water affinity using the wet capacity and drying time. Detailed expression is possible when water exists in a scene. Thus, various scenes with water can be depicted more realistically, which is a very important component of special effects.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for expressing wetting and drying on an object surface, the apparatus comprising:
an adding water mark module searching positions of waterdrops contacted with an object surface to add water mark to the object surface;
a wetting module using water affinity of the object surface to move water particles to the positions of the waterdrops;
a 2D fluid simulation module simulating a flow of surplus water particles in excess of a wet capacity according to the water affinity of the object surface to calculate speed values of the surplus water particles; and
a drying module removing old water particles that pass a predetermined time to express wetting on the object surface after comparing time of each frame.

2. The apparatus of claim 1, wherein the object surface is expressed as a 2D lattice, and each cell constituting the 2D lattice has a limitation in accommodating the number of the water particles according to characteristics of the object surface.

3. The apparatus of claim 1 or 2, wherein the water affinity of the object surface is expressed using the wetting capacity of each cell constituting the 2D lattice and a drying time of wet cells.

4. The apparatus of claim 3, wherein the wetting capacity is the number of water particles held in and limited by each cell constituting the 2D lattice.

5. The apparatus of claim 1, wherein the adding water mark module regards a simulation result, i.e. a particles or a vertex of a mesh, generated using an additional simulation tool in outside as one waterdrop, and generates water mark by searching and adding position information of the waterdrops, which affects the object surface.

6. The apparatus of claim 1, wherein the adding water mark module moves the surplus water particles to expand wet portion of the object surface using the speed values of the surplus water particles calculated from a 2D fluid simulation result of the 2D fluid simulation module.

7. A method for expressing wetting and drying on an object surface, the method comprising:
adding water mark to an object surface after searching positions of waterdrops contacted with the object surface;
adding water particles to the added water mark using water affinity of the object surface, dividing the object surface of a 2D lattice into wetting portion and drying portion, and managing surplus water particle information in each cell constituting the 2D lattice;
simulating a flow of surplus water particles in excess of a wet capacity according to the water affinity of the object surface to calculate speed values of the surplus water particles;
expressing wetting of the object surface by completing water particle distribution of the object surface after using the calculated speed values of the surplus water particles to move the surplus water particles; and
expressing drying of the object surface by comparing a wetting time of each cell in each frame to remove old water particles that passes a predetermined time.

8. The method of claim 7, wherein a simulation result that is a particle or a vertex of a mesh, which is generated using an additional simulation tool in outside, is regarded as one waterdrop, and water mark is generated by searching and adding position information of the waterdrop during the adding of the water particles.

9. The method of claim 7, wherein the expressing of the wetting water expands the wetting portion of the objects surface by moving the surplus water participles to positions of waterdrops contacted with the object surface.

10. The method of claim 7, wherein the object surface is expressed as a 2D lattice, and each cell constituting the 2D lattice has a limitation in accommodating the number of the water particles according to characteristics of the object surface.
